(19) United States
(12) Patent Application Publication
(10) Pub. No.: US 2025/0182552 A1
(43) Pub. Date: Jun. 5, 2025

(54) System and method of secret online voting countering vote stuffing and substitution, vote trading and pressure on voters

(71) Applicant: Aleksandr Khrabryi, Princeton, NJ (US)

(72) Inventor: Aleksandr Khrabryi, Princeton, NJ (US)

(21) Appl. No.: 18/915,199

(22) Filed: Oct. 14, 2024

(51) Int. Cl. G07C 13/00; G06Q 30/018; H04L 9/08

(52) U.S. Cl. CPC G07C 13/00; G06Q 30/0185; H04L 9/0825; G06Q 2230/00

(57) ABSTRACT

The proposed system and method eliminate the possibility of vote loss, stuffing and substitution during secret online voting. Voters can verify the accuracy of their votes in the final results only during the public procedure. They also have the option to change their choice within the allotted voting period, eliminating the motivation behind vote trading and coercion. Results are available to all participants immediately after the voting concludes. Additionally, a view of the social distribution of preferences can be obtained. At the core of the system are personal devices connected into a peer-to-peer network. The invention relies on direct messaging between devices within the network, employing asymmetric multi-stage encryption, distributed storage of information with redundancy, and independent processing by each device. Together, these elements minimize the computational resources and financial costs for voting organizers.

### FIELDS OF THE INVENTION

The present invention relates to the field of electronic balloting systems and, more specifically, to systems and methods of electronic voting conducted over a public data network such as the internet using personal smart devices, in particular, mobile communication one.

### BACKGROUND OF THE INVENTION

Currently, due to the ubiquity of personal computer devices connected to public networks, it has become possible to use them for online secret ballots eliminating the inconveniences inherent in traditional methods of secret voting.

### The Prehistory

The initial idea of using computers in voting was to use them in all voting-related information processing and storage.

This idea is reflected in U.S. Pat. No. 6,175,833B1 “System and method for interactive live online voting with tallies for updating voting results” with priority dated Apr. 22, 1998, the inventors of which are Brenden West and Sean Anderson. In this patent, a system and method of interactive online voting were claimed, covering the entire process from introducing alternatives, creating and distributing ballots with these alternatives, to receiving votes (no more than one from one voter), saving them, and presenting them as they accumulate.

This general idea will likely always be of relevance. However, it did not highlight or take into account the difficulties of ensuring secret voting and did not provide for countering malicious actions of persons participating in the voting.

The search for practical implementation of the concept of using computer technology in the organization of secret ballots revealed many problems, the resolution of which was carried out in completely different ways recorded in a variety of inventions. In addition to solving these problems, these inventions reflected the desire of the inventors to use the latest scientific and technical achievements in the voting process, the introduction of which in turn generated new problems.

From Paper Ballots to Voting from Personal Computer Devices

The first implemented and reflected in the patents were the ideas of using specialized devices for receiving votes integrated into a local network. Initially, such devices were supposed to simply accept machine-readable ballots and accurately count the votes cast. The voter could vote in person at the polling station, or send a machine-readable ballot by mail to the address of his precinct. Over time, from the simple automation of counting votes cast by a voter who passed traditional authentication at a polling station, received a paper ballot there, and sent this ballot at the same polling station to a reader that transmits information to the vote-counting center, it switched to paperless devices for entering the voter's vote. Such devices had to have an interface that allowed the voter to make his choice using it. Over time, the Internet and telephone networks began to be used to communicate between specialized devices that read ballots or accept voters' choices. In all variants, it was envisaged to combine these devices into a two-rank network designed to transfer the votes they received to the server where the counter is located.

The next implementation reflected in the patents were the ideas of using any personal computer device for receiving voices instead of a specialized device, whether it is a personal computer, laptop, tablet, or smartphone (phone). At the same time, sending votes to the counter to the server could be done through the website or through the application. The technology, which allows the voter to use different devices, required the provision of a means for the voter to confirm his right to cast a vote in a particular vote. Moreover, the use of this tool should not have prevented the anonymization of votes. Such tools have become a token executed on a separate device, an electronic certificate, or a PIN code.

The application for patent U.S. Pat. No. 6,175,833B1 “Electronic voting system” with priority dated Jun. 12, 2000, the inventors of which are Jared Karro and Jie Wang, provided encryption with a key that is stored in an authentication tool issued to the voter by the organizers of the vote during its registration, and a special device for receiving votes, providing confirmation that votes were cast using ballots with an identifier indicating that they were issued at the distribution point and that the voter voted at the registration point. At the same time, it was claimed that the authenticated votes and the ballot ID were transferred to a remote counter using the Internet.

In patent U.S. Pat. No. 7,549,049B2 “Dynamic auditing of electronic elections”, with priority dated Jul. 8, 2005, the inventors of which are John J. Bogasky and Carl Almond proposed a system in which an authenticated voter receives a digitally signed ballot from a local election bureau, fills it out, signs it with his digital signature using a roaming digital certificate, encrypts it with his symmetric key, encrypts his symmetric key with the public (asymmetric) key of the local election bureau, stores the encrypted symmetric key and the associated it has an encrypted ballot in the electronic ballot box of the local election bureau.

In U.S. Pat. No. 11,038,675B2 “Electronic voting using secure electronic identity device”, with priority from 2016 Sep. 19, the inventors of which are Milan J. Krizenecky, Michael Webster, and Michal Botka, a system is proposed that includes two servers: the server of the registration authority and the server of the election authority, the voter's computer, allowing him to vote when his electronic ID card is connected. During the registration process, the registration authority's server and the secure electronic identification card establish the first alias for the secure electronic identification token, which is unique for the electronic identity card and the registration authority. The registration authority records the voting rights attribute on the electronic identity card. During the voting process, the electoral authority's server extracts the second alias (which is associated with the electoral authority) and the voting rights attribute from the electronic identity card and records on the electronic identity card the attribute indicating the receipt of the vote cast by the voter.

U.S. Pat. No. 11,049,349B2 “Computerized voting system” with priority dated Nov. 22, 2017, the inventor of which is Daniel W. Onischuk (valid until 2025) describes a procedure in which officials create lists of registered voters, to whom machine-readable encoded documents (registration, language selection, voting ballots), additional containers for a refund. Each document is linked to the receipt by means of a common unique random symbolic identifier and other security elements. In order to ensure the confidentiality of voting, voters exchange ballots within their electoral region. Voters fill out the document(s), add a personal security identifier, save a receipt for the document, and send documents to officials in person or by mail, delivery service, by phone, fax or via the Internet, e-mail, interactive television. Image processing machines record documents, duplicate images, match RSIDS, and store data in a private voter data warehouse along with completed and counted ballots.

U.S. Pat. No. 11,138,821B2 “System and method for hybrid model electronic voting”, with priority dated Oct. 7, 2019, the inventor of which is Matthew Heuman, proposes an electronic voting system based on a special voter device that allows him to remotely vote electronically. This device, which includes a screen and provides the formation of a command for the voter to enter his choice in the ballot, is connected to a data transmission network. The proposed system also includes a portal server containing a database storing information about the eligibility of voters, connected to a data transmission network and configured to verify the eligibility of a voter casting his vote remotely through a special device. In addition to the personal device and the server, the system includes a voting machine that includes a physical marking device (which creates a physical ballot and makes a voter's choice in it) and a camera that takes pictures of this ballot. The voting machine communicates with the server via a data network, which may be the Internet.

In U.S. Pat. No. 11,600,128B2 “System and method of casting a vote in an electronic voting system”, with priority dated May 21, 2020, the inventors of which are Alexandra M. Nikolina, Alexander S. Korunov, Alexander V. Sazonov, Ochir V. Abushinov, Zoya S. Sergeeva, a method is proposed to increase the reliability of accounting for votes cast by two-factor confirmation of each votes, due to the fact that after a predetermined time has elapsed since the registration of the electronic vote of the voter, a deferred request is formed to the voter to confirm the relevance of the electronic vote submitted by him. The method generally includes authentication of the voter from whom the voting request was received, generation of his electronic ballot based on voting information, collection of data on electronic voting of the voter representing the voter's choice in the electronic ballot, formation and sending to the voter at least one request to confirm the validity of the collected data on electronic voting, creation of a printed copy of the completed of the ballot by the voter, placing the created printed copy in a centralized repository, counting the votes of the voter, when a hard copy of the ballot has been successfully generated and an affirmative response has been received from the voter in response to at least one request.

U.S. Pat. No. 9,292,987B1 “System and method for fully encrypted remote web-based voting”, with priority dated Sep. 22, 2014, the inventor of which is David Myr, proposes a method in which voting data is fully encrypted, including encryption inside the database, until the end of the voting period. A computer system configured to receive encrypted voting results data and send such data in encrypted text to a central election server to store the database and prevent everyone, including database administrators, from viewing the data. A method of secure data encryption and calculation of public keys based on a secret PIN code (as a certificate) of a voter (issued by trusted persons) is presented. Each vote remains individually encrypted from the moment of voting until it is decrypted by authorized representatives of the election commission at the end of the voting period.

U.S. Pat. No. 11,640,616B2 “System and method of counting votes in an electronic voting system”, with priority dated Oct. 16, 2020, the inventors of which are Roman V. Aleshkin, Maxim V. Riveiro, Artem G. Nagorny, Evgeny N. Barkov, Mikhail D. Kudryavtsev, proposes a method for organizing electronic voting, in which first occurs generation of a number of tokens, each of which uniquely identifies one voter and provides him with the opportunity to choose a token during electronic voting. This token, upon presentation to the access device, activates the ballot, unambiguously associating the token selected by the user with this ballot. At the same time, the access device provides the voter with access to the ballot during the pre-allotted time, checks the validity of the submitted ballot, and counts the ballots filled in by the user. Activation includes indications of which votes the user can participate in using the token and the amount of time allowed to cast a vote. The token is intended for one-time use and contains at least one of: a QR code, a barcode, a sequence of key characters, or an RFID tag. The number of tokens generated exceeds the total number of voters. The token allows you to confirm the validity of the ballot filled out by the user both by the server and subsequently by the voter himself. The secrecy of voting is caused by the lack of communication between a randomly selected token and a specific user.

U.S. Pat. No. 10,109,129B2 “Express voting”, with priority dated Jan. 24, 2014, the inventors of which are Eric James Joyce, Craig Harold Reines, and Anthony Kelly, provides for voter authentication at a kiosk at a polling station based on a token carried by the user equipment, and the token is associated with at least one of the voter's identity cards. In response to the successful authentication of the voter and the connection of user equipment to the voter kiosk via a short-range communication channel, the electronic submission of the ballot paper to the user equipment of the voter is sent via a short-range communication channel. Scanning by the voter kiosk of a barcode displayed on the user equipment, with the barcode encoding one or more choices made by the voter. Demonstrations by the bulletin kiosk with the choice made by the user on their equipment. Summarizing the voting results in response to receiving confirmation from the voter of the correctness of the kiosk's reflection of his choice.

U.S. Pat. No. 9,652,920 “Voting systems and voting methods based on smart mobile communication devices” with priority dated Jun. 21, 2012, the inventor of which is Lihao Chen, claims a system that contains more than one intelligent mobile communication device, more than one server, client modules and server modules. Client modules are installed in smart mobile communication devices and, accordingly, provide temporary storage of information about voters, submitting requests for identity certification, displaying a request for voting, and submitting voting results to voters. Server modules are installed in the servers; each server module contains a voter management module, a certificate management module, and a ticket (token) management module and, accordingly, a repository of information for voters, register certification and voter identity certification, certificate generation, generation of the electoral process, publishing, and statistics, as well as publication of voting content. Client modules and server modules via a mobile communication network carry out data transmission. Upon request of the client module for a voting certificate, after accumulating a certain number of such requests and verifying them, the server creates such certificates using asymmetric encryption keys and issues them to voting devices in random order, then receives their votes from voters' devices, signed by them using these certificates, checks them for compliance and includes them in the calculation the result.

U.S. Pat. No. 11,837,031B2 “Distributed voting platform” with priority dated Jul. 7, 2016, the inventor of which are Arthur Andrew, Montgomery Scotson, claims an automated voting platform that provides: 1) connecting a remote voting system via a network, on the one hand, to a client computing device containing a user interface, a face scanner, location information and a network address, on the other hand, to a state voting system; 2) creation of an account for a user on an automated voting platform and identification of this account; 3) permanent or periodic authentication process with the repeated provision of biometric information, including face scanning; 4) access to voting by an authenticated user and to viewing information about elections by an unverified one.

U.S. Pat. No. 11,847,865B2 “App-assisted voting”, with a priority date of Jan. 21, 2021. The inventors are Jacek Joseph Matysiak and Dilinur Wushour. This invention describes a method in which an application is installed on a mobile device with memory that stores the program code for the voting app and a processor that is connected to memory. First, the user registers by linking their personal information with a pre-assigned code using the voting application on a cloud server of a voting authority. During the voting process, the voter is authenticated by the server of the authority, and their authorization via the server allows them to use the app. The ballot is then transferred from the server to the application, where the voter makes their choice and saves it in memory using the app. The voter then receives a login to the voting server via the voting application. After the voter is authenticated by the server, an authentication token is issued by the polling server to the application. Then, network connections are made to a multifunctional printer for voting and confirming the voter's identity using the authentication token through the application as a proxy. After this, the election ticket is issued and the selected option is sent to a multi-function printer for voting, along with the ticket. The process can include printing voting results on the multi-functional printer, scanning the printout on the printer, transferring the scanned contents to the app, confirming it, and sending the scanned information to the server.

In U.S. Pat. No. 11,361,606B1 “Tamper resistant public ledger voting system”, with priority dated Nov. 29, 2020, the inventors of which are Oren Zbeda and Eran Eliyahu Tobul, a voting system is proposed in which the server of the voting organizer distributes many different pairs of private (secret) and public keys anonymously to each voter, publishes a list of public keys in a public registry; receives a voter's vote encrypted with a secret key; records it in a secure public registry that includes a blockchain; uses this record to count the voting results. The recorded encrypted vote is verified by the election commission, and after its confirmation is encrypted with the private key of this election commission, which leads to the receipt of a twice encrypted confirmed vote. Verification is reduced to checking a set of secret keys and associated public keys. The list of voters who received the private key is published.

The main constant problems that the inventors solved by implementing the above-mentioned ideas of using computer technology in organizing secret ballots were the problems of allowing only those voters who have the right to vote to vote, receiving an anonymous vote from an authenticated voter, saving it and transferring it to a vote counting device with subsequent publication without distortion, as well as the possibility of verifying the correctness accounting for the votes cast without disclosing the secret of voting. In all the inventions described above, a two-rank network was used, implementing a classic scheme in which, on the one hand, there were non-verifiable voting organizers, certainly trusted persons, and on the other hand, verifiable voters. All these inventions are aimed at passive counteraction to third-party unpredictable intruders. At the same time, in all the inventions described above, the possibilities inherent in traditional voting for committing any type of malicious actions are viewed to one degree or another, and, what is essential, ones carried out in simple ways. These are violations of the secrecy of voting, vote trading, pressure on voters, and ballot stuffing carried out on the initiative of unscrupulous organizers and administrators of voting who control the server.

### Voting Using the Blockchain

One of the means to eliminate the decisive role of the server, which may be controlled by intruders, and at the same time ensure reliable preservation of information used in secret voting, has become a blockchain, which combines peer-to-peer voting and storing information in a distributed registry, so that information about all is stored in each node of the registry transactions made by each participant of the network.

U.S. Pat. No. 11,323,262B2 “Method and system for verifying a voter through the use of blockchain validation”, with priority dated Mar. 13, 2019, the inventor of which is Paul Zawierka, proposes a method that boils down to the reception by several processors of voter identification information associated with his account and its verification for the right to vote according to the requirements of the organizer, encrypting part of this information and storing the encrypted and remaining parts separately in the blockchain. Based on this information, after requesting a vote from a voter's account, several processors obtain access to a voter's account, verify this record for his right to vote and whether he has already voted, after which several processors receive a voter's vote, with his signature from his account and save one part of the voting data in an encrypted format and other parts of this data are in an unencrypted format on the blockchain. At the same time, identification information may include biometric data and signature, received vote, global positioning data and voting time.

U.S. Pat. No. 10,790,964B2 “Peer voting on a blockchain” with priority dated Nov. 17, 2017, the inventors of which are Anuj Chopra, Zhou Yinsheng, Yuan Yuan and Wenbin Zhang, proposes a voting method in which each identified device splits the vote submitted by its owner for one of the alternatives into several parts and sends these parts to others to the devices participating in the voting, each device places the received parts of the votes in a blockchain supported by the devices participating in the voting. At the end of the voting, each device counts the total number of parts for each of the alternatives in the blockchain.

U.S. Pat. No. 11,663,872B2 “Computer implemented method of online voting and vote validation” with priority dated May 11, 2021, the inventor of which is Benjamin J. White, states a method for submitting votes from any computer device connected to the Internet, in which an electronic ballot filled out by a voter is stored in two encrypted (or not encrypted) copies: in the form of a record in the database and in the form of an electronic document, each of which is sent to a separate blockchain. The number of valid ballots taken into account includes only the ballot whose copies matched after decryption and comparison.

U.S. Pat. No. 9,836,908B2 “System and method for securely receiving and counting votes in an election”, with priority from 2015 Aug. 6, the inventors of which are Nikolaos Spanos, Andrew R. Martin and Eric T. Dixon, states the use of branched blockchain technology developed by the same inventors to store secret ballot data in an electronic voting system. The system includes a network of voting machines. Each voting machine is equipped with a barcode scanner, a network communication device, and a computer system running the voting client. Votes are received through a barcode scanner or a voter interface system and stored on the blockchain. The vote count of the various candidates in the election is updated and saved as each vote is received and counted. This creates a verifiable vote trail and vote count that can be used to detect, correct, and prevent fraud and errors in the vote counting process.

U.S. Pat. No. 11,394,773B2, “Cryptographic currency block chain based voting system” with priority ending on Jun. 25, 2039, the inventor of which is Jim Austin Joseph, proposes the most obvious version of the voting system: using cryptographic currency. In the proposed system, identifiers are created for each alternative to a specific survey, a cryptographic currency address is generated for each such identifier, a certain number of tokens is transferred to each such address by the voter through the cryptographic currency network, where it is confirmed and included in the block chain registry. The voter has such a number of tokens of each alternative that corresponds to the weight of his vote, which allows for a weighted vote (the mechanism for acquiring these tokens is not described in the invention).

U.S. Pat. No. 11,961,336B2 “Distributed ledger-based voting system, apparatus and method” with priority on Jun. 7, 2022, the inventor of which is Dennis Lyon, states a method for remote voting using an application associated with the source address of Ethereum NFT 0x7beaD10F8dE9fFd99A0E897840D6105BBBC1184f. Potential voters send registration requests to the distributed registry, and each computing node of the distributed registry, executing a smart voting contract, registers potential voters and issues each registered voter a cryptographic voting token. Each registered voter uses a cryptographic voting token to submit an electronic ballot, and the electronic ballot contains a request for a voting transaction based on a distributed registry. Each voting transaction request is accepted by each computing node of the distributed registry and verified, and a verified voting transaction based on the distributed registry is created and verified along with other verified voting transactions by each of the computing nodes. When verified voting transactions are confirmed, a cryptographic block is created, which is added to the distributed registry blockchain. After the voting is completed, each of the computing nodes verifies the final count of the voting tokens received by each candidate, and the final cryptographic block is published in a distributed registry with the results.

In U.S. Pat. No. 11,488,433B2 “Method and system for public elections on a moderated blockchain” with priority dated Jan. 11, 2018, Steven C. Davis proposed a method for processing votes in a public blockchain, which includes: generation by the server of election reference sand candidate references; generation by the server of a pair of asymmetric cryptographic keys consisting of the main the secret key and the main public key; creation of a registration block to be added to the blockchain, including a link to the elections, links to candidates and the main public key; transmission of the registration block to nodes associated with the blockchain; reception by the server from voters' devices of multiple voting messages, each of which includes voting and a mention of the election, and voting includes a mention of the voter and at least one mention of the candidate; creation of one or more voting blocks to add to the blockchain, including received votes; and the transfer by the server of each generated voting block to nodes associated with the blockchain.

U.S. Pat. No. 11,869,018B2 “Voting system to prevent fraud using blockchain technology” with priority dated Dec. 23, 2020, the inventors of which are Nathaniel Loyd, John Wesley Barron and Joshua Jarrell, states a system that contains at least one voting machine and a method that includes initialization of the blockchain using a primary block In this case, the source block contains the original data set and the hash value of the source block, receiving a signal representing a transaction, and each transaction includes voting, creating a data structure, containing the transaction and the hash value of the previous block, determining the new hash value of the data structure block and adding a new block containing the data structure and the hash value of the new block to the blockchain. The claimed method provides for receiving a message corresponding to a transaction through a smartphone application, and distributing the blockchain (which can be encrypted) to many user devices, and providing the source of each transaction with a receipt that contains the corresponding hash function value.

In U.S. Pat. No. 10,977,887B2 “Voting method” with priority dated Apr. 17, 2019, inventor Hendrik Hackmann proposed a method in which a voter casts his vote in a voting machine that stores three lists: the voter list, which includes the first entry in which this person is registered, the voting list, which is separate from the voter list, and the list of links, which consists of hash values of the votes cast and is separated from both the voter list and the voting list. The voting machine generates a second entry in the voting list, recording the cast vote; then calculates the hash value of the second voting entry in the voting list to form a link; generates a third entry in the link list and writes the link to the link list. At the same time, the list of voters, the voting list or the list of links is a blockchain, and voting machines are located at the polling station.

Patent US20230370269A1 “Distributed ledger platform for electronic voting and/or polling” with priority dated May 11, 2023, the inventors of which are My T. Thai and Truc Nguyen, states a method and device for electronic voting and/or polling using a distributed registry. The method provides for the reception by a node computing device of a distributed registry of a transaction commit request, which includes one or more encrypted voices, proof of cryptographic authentication and/or proof of input verification. The fixation is performed during the execution of a smart contract to (i) authenticate the user ID associated with the transaction based on proof of cryptographic authentication and (ii) verify one or more encrypted voices based on proof of input verification, which is a non-interactive zero-knowledge proof protocol. In the case when the smart contract authenticates the user ID and confirms one or more encrypted votes, the data block associated with the transaction is added to the distributed registry.

The problems inherent in voting in the blockchain of ensuring the secrecy of voting, that is, the anonymity of the votes cast, are reflected in an invention specifically dedicated to this issue.

In U.S. Pat. No. 11,749,047B2 “Electronic voting system and control method”, with priority dated Aug. 18, 2020, the inventors of which are Yuji Unagami and Junichiro Soeda, announced in China in 2017, it is proposed to use mathematical methods for determining anonymization in a system where one of the many voting servers receives voting data from terminals, including an identifier related to the vote cast by the voter and information about the vote. After determining that this data meets a predetermined anonymization criterion, it generates two blocks, one of which includes voting data that meets a predetermined anonymization criterion, and the other-data that does not meet these criteria. Attaches these blocks to the blockchain stored in memory (with the second block connected to the voter) and generates a screen of voting results reflecting this information. It is assumed that compliance with the anonymization criterion is established by consensus of the servers.

In the inventions described above, aimed at using blockchain in conducting secret ballots, the emphasis is on reliable preservation of information about voters and their votes. At the same time, in some of these inventions, there is even a lack of guarantees of anonymity, many lack mechanisms to verify the correctness of accounting for votes cast, and in those where these mechanisms exist, measures are not provided to prevent vote trading and counteract pressure on voters.

Peer-to-Peer Voting without Using Blockchain

An alternative tool designed to exclude the possibility of influencing the voting process through a server endowed with a special role has become voting systems and methods in a strictly peer-to-peer network using a distributed registry but without the features characteristic of the blockchain.

One of the first attempts to reduce the ability to influence the results of voting by its organizers was U.S. Pat. No. 6,704,887B2 “Method and apparatus for improved security in distributed-environment voting” with priority dated Mar. 8, 2001, the inventors of which are Kevin A. Kwiati and Benjamin C. Hardekopf. It suggests using a local network in which voting is started by the majority of its participants, sending each of them his vote to everyone else in the buffer of accumulation of results, followed by their approval when most of them find their vote in this buffer (encryption is not provided).

U.S. Pat. No. 10,979,225B1 “Secure and anonymous electronic polling” with priority dated Nov. 15, 2018, the inventors of which are Trupti Shiralkar and Joshua Stevens, proposes a system in which a homomorphically encrypted voter's vote, his digital signature and a voting access token from a voter's device are accepted by other devices, the signature and token are verified by several of them (according to a hash value based, at least in part, on the unique hardware identifier of this device and its type), after that, the voice is stored in the data warehouse and recorded in a publicly available distributed registry (while neither decryption nor publication is provided).

In patent EP3574482B1 “Voting system and method”, announced on Jan. 30, 2017, inventor Max KAYE proposed a voting system and method in which each voter is identified by a single public identification key, and the system includes nodes for collecting and combining votes into a container and storing this container in a public data warehouse. The nodes of the system transfer public voting keys to each other, using cryptography to remove the link between public voting keys and public identification keys to create a list of anonymized public voting keys. After removing the link between the public voting keys and the public identification keys, each node transmits votes authenticated by anonymous public voting keys to create anonymous votes and combine them into a voting container. The version of this invention, published on Aug. 2, 2023, under the number EP3574482B8, introduces an electronic signature that establishes an association between voting public keys and the identity public keys. The system and method proposed in these patents do not prevent vote stuffing in the early version, and in the later version, by countering vote stuffing, they do not exclude vote trading and voting under pressure.

### Verification of Voting Results

The problem of verifying the correctness of accounting in the voting results of the choice made by the voter has become the object of several inventions.

In U.S. Pat. No. 11,062,546B1 “Voting systems and methods for encoding voting selection data in a compressed format” with priority dated Dec. 23, 2020, inventors Michael Davis, Bruno Roger, Casey Ballentine, Christopher Horvath and Kevin Day disclosed various voting systems that include a device that: 1) presents the voter with several alternatives for one or more votes and allows the voter to choose one or more alternatives for each vote; 2) create a bitmap containing a set of bit cells, each of which corresponds to one of the alternatives of one vote, while each of the bit cells stores a binary digit that indicates whether the voter has chosen an alternative corresponding to this bit cell; 3) converts binary digits stored in a bitmap image into a compressed string of characters; 4) generates one or more selection barcodes that encode a compressed string of characters; and 5) prints one or more selection barcodes on paper to create a paper ballot. Voting systems also include a summarizing device designed with the ability to: 1) reading one or more selection barcodes printed on a paper ballot, 2) decoding a compressed string of characters; 3) converting a compressed string of characters into binary digits; 4) analyzing binary digits to determine the selected voting options; and 5) storing selected voting options in the minutes of votes cast.

In the patent application US20230147564A1 “System And Method For Conducting A Publicly Auditable Election” dated Nov. 8, 2022, inventor Carey Robert Briggs proposed a method of conducting elections in which a voter can check whether his ballot was counted in the election result in this order in which it was submitted, and cryptographically prove whether his newsletter has been changed or deleted. The method involves converting a voter-filled ballot into a predefined format; cryptographic signature of this ballot using a cryptographic processor with the private key of an asymmetric pair stored with the voter; transfer to the server of the formatted ballot along with the signature of the formatted ballot, the public key of this signature, the identification characteristic of the cryptographic processor; then signatures using a cryptographic processor of the formatted ballot with the private key of an asymmetric key pair supported by the election authority; after that, the transfer of the signature of the authority on the formatted ballot paper to a computing device in such a way that the voter can receive the specified signature.

In U.S. Pat. No. 11,069,170B2 “Method of verifiable and anonymous voter receipt for electronic voting system” with priority dated Dec. 4, 2017, Zhenxiang Zhang stated a voting method that uses an anonymous, verifiable, secure and forgery-free receipt, preserving secrecy and transparency. In this voter's receipt, the voter's choice is printed by entering into one of the lines of the ballot a unique voter number, which is a series of numeric numbers, letters or combinations of numbers and letters randomly generated by the electronic voting system, and his signature, which consists of at least two numbers, letters or symbols randomly generated by the voter the database. In addition to the voter's choice, in the same receipt, the system fills in all the lines of the ballot, in which the unique numbers of other voters with their signatures are printed. The voter's receipt can be printed on paper, recorded on a storage device, sent by mobile phone or sent by e-mail; the voter's receipt can be checked against the published election results. This method can be used in an electronic voting system connected to the local network of the polling station, mobile network or the Internet.

All the proposed options for secret voting, in which the voter can see how his vote is taken into account in the results, turned out not only to be unprotected from vote trading and unable to counteract pressure on the voter but also contributing to these deviations.

In all of the above inventions, there are ways in which attackers can hamper the achievement of the goals stated in these inventions. For example, by controlling the server, it is possible to carry out undetectable vote stuffing and even their substitution. But even in the absence of a server, when hidden stuffing and vote substitution are excluded, there remains an insurmountable contradiction between ensuring the secrecy of voting, on the one hand, verifying the reliability of the results, on the other hand, and countering vote trading and voting under pressure, on the third. The set of problems that need to be solved when creating a reliable online secret voting system is described in detail in the article “Going from bad to worse: from Internet voting to blockchain voting”, published on Feb. 16, 2021, in the Journal of Cybersecurity, Volume 7, Issue 1, 2021 under the auspices of MIT by authors Sunoo Park, Michael Specter, Neha Narula, and Ronald L Rivest, and based on the analysis of more than 106 patents, publications and reports on the operation of existing systems. The search for answers to the critical questions posed in this article leads to the need to make public control of all procedures that make up this process and its results an integral element of online voting systems, as well as the inclusion in this process of reliable measures to counter malicious actions of any parties.

### SUMMARY OF THE INVENTION

The online voting system and method stated in this disclosure differs from existing online voting systems by the expanded list of goals, as well as the composition and simplicity of the means used to achieve these goals.

The set of objectives of the present invention includes ensuring: firstly, the impossibility of stuffing and substitution of votes; secondly, the implementation of secret voting while preserving the ability of the voter to verify the correctness of the registration of the vote he submitted in the voting results, excluding the possibility of requiring the voter to present the result of such verification (ensuring the senselessness of pressure on the voter) but preserving the voter has the opportunity to present his vote during the trial while disclosing the secret of voting at will; thirdly, the ability of the voter to change his choice during the time allotted for voting (making it pointless to buy votes); fourthly, obtaining the results by all voting participants immediately after its completion; fifthly, minimizing the computing resources required to ensure the goals set; and finally, sixth, the low cost of voting for its organizers.

The achievement of these goals is based on the integration of users' personal computer devices into a peer-to-peer network, the use of rhythmed anonymizing mailings, distributed storage of information encrypted with personal keys generated by each network participant device separately, and the specificity of sets of encryption, distribution, decryption, and storage procedures performed by each device separately.

### BRIEF DESCRIPTION

During the voting process, the devices of its authenticated participants join a network (for example, peer-to-peer or hybrid), which is formed for the current voting.

A device that has joined the voting network creates an asymmetric encryption key pair and a voting key. The asymmetric encryption key is used in the anonymizing mailing. The voting key is used to ensure the secrecy of voting and the ability to re-vote during the time allotted for voting. This exclude both loss or substitution of the submitted vote, and obtaining interim results before the end of voting. In one implementation, the device that joined the voting network additionally creates an identifier designed to exclude the participation of non-authenticated persons and multiple involvements of the same person, verify the presence of the cast vote in the voting results and exclude substitution. In another implementation, the identifier is the voting key.

During the voting, the voter's device participates in various processes. In one of the implementations of the present invention, immediately after successful authentication of the voter, their device creates its identifier for the current vote, which consists of two parts, one part of which is anonymously published (sent to other devices and the server via an anonymizing mailing), and the other part remains hidden. In all implementations, during the time allotted for voting, the voter can make their choice and cast their vote. The voter's device encrypts this vote with the voting key it generated. Then, the voter's device anonymously places this vote in an encrypted form in open access. Each voter's device collects the encrypted votes placed in open access by other devices. After the time allotted for vote casting has elapsed, all devices anonymously place their voting keys in open access. Then each device decrypts all the encrypted votes it has collected, which were sent by other devices, using the keys placed in open access. Then, each device places the votes decrypted by it in open access and collects all decrypted votes placed in open access by other devices. After this, using the decrypted votes collected, each device counts the number of votes cast for each alternative independently of other devices. Each device then places its result in open access where any other device or user can verify this result using the full list of the decrypted votes of the voters. The voting results and the full list of votes can be visualized in the voting system (for example, published on the voting website).

The server is used to start and complete the voting process, rhythmize anonymizing mailing, save and publish the final list of votes cast and final voting results. It can also be used to exclude the possibility of publishing intermediate results. To do this, it will need to generate a pair of asymmetric encryption keys to identify the current voting. With the public key from this pair, all devices will additionally encrypt encrypted votes of their users. These votes can be decrypted only after the server publishes the private key from this pair.

The anonymous placing of messages in open access is provided by the anonymizing mailing. In the process of the anonymizing mailing, at first, a group of several devices are combined into a group network. Then the devices of this group exchange messages in two stages. During the first stage, each of the devices combined in the group network sends a public key from the key pair for anonymizing mailing, generated by it, to all the devices of the group. Each device also collects such keys from other devices of the group, and saves each of them with the network address of its sender. In the second stage, each device selects several keys from the received keys and sequentially encrypts its message with these keys, attaching the key with which it was encrypted to the encrypted message at each encryption step. At the next stage, each device sends a multiple encrypted message to the device whose key is attached to this message and receives messages from other devices that are encrypted with its public key of the anonymizing mailing. Each device decrypts the received messages and if it is encrypted after decryption, it sends it to the device whose key is attached to it, otherwise, if the received message is completely decrypted by it, it sends it to all the devices of the group and the serve.

Anonymizing mailing is based on asymmetric encryption and direct (without intermediaries) messaging between the participating devices. The server in the anonymizing mailing can be used to form groups and for the rhythmization of the process of anonymizing mailing.

The features of the proposed invention are 1) the opportunity to change the vote repeatedly during the time allotted for voting, 2) the possibility of including in the message containing the voter's vote any information added by the voter, in particular, non-personifying personal information about the voter, allowing for a sociological analysis of the voting results, 3) the inability to arbitrarily see a vote of any select voter in the voting results, while that this can be done in a public procedure, 4) a comprehensive set of tools that exclude stuffing and substitution of votes.

### DETAILED DESCRIPTION OF THE INVENTION

### Preliminary Remarks

The terminology used here is intended only to describe specific embodiments and is not intended to limit the invention. The term “and/or” used here includes any combination of one or more related listed elements. The singular forms “a”, “an” and “the” used here are intended to include plural forms as well as singular forms, unless the context clearly indicates otherwise. It should also be understood that the terms “includes” and/or “includes” used in this description indicate the presence of the claimed features, stages, operations, elements and/or components, but do not exclude the presence or addition of one or more other features, stages, operations, elements of components and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The description and the claims of the invention disclose a number of methods and their constituent steps. Each this steps has an individual advantage, and each of them can also be used in combination with one or more, and in some cases with all other disclosed steps. Accordingly, for greater clarity in this description, we will refrain from unnecessarily repeating all possible combinations of individual methods and stages. Nevertheless, the description and the claims of the invention should be read with the understanding that such combinations fully correspond to the scope of the invention

In each claim, a number of individual actions are disclosed, each of which has an individual purpose, and can be used in combination with one or more, and in some cases, with all other disclosed individual actions. Accordingly, for greater clarity in this description, we will refrain from unnecessarily repeating all possible combinations of individual actions. With this in mind, the description and the claims should be read with the understanding that all such combinations fully correspond to the scope of the invention.

In this description, for purposes of explanation, numerous specific details are set forth in order to provide a thorough understanding of the present invention. It is evident, however, that the present invention may be practiced without these specific details.

The description and the claims of the invention disclose a number of methods and their constituent steps. Each of them has an individual advantage, and each of them can also be used in combination with one or more, and in some cases, with all other disclosed steps and methods. Accordingly, for greater clarity in this description, we will refrain from unnecessarily repeating all possible combinations of individual methods and stages. Nevertheless, the description and the claims of the invention should be read with the understanding that such combinations fully correspond to the scope of the invention.

This description should be considered as an illustration of the invention. It is not intended to limit the invention to the specific embodiments described below. The use of the phrases “either . . . or . . . ”, “in one of the options”, “in a particular case”, “maybe”, “for example,”, “etc.”, “perhaps” and the like serves to indicate that only one of the possible implementation options is presented, and that the presented option does not exclude, but suggests other options.

In this description and the claims of the invention, a “user” is a person who has a device connected to a public computer network. “Device” means any smart device of the user, which may be a personal computer, laptop, tablet, smartphone, or software module having its own network address. “Server” means any computer device, combination of computer devices, or software module, in particular a distributed one, performing the actions prescribed by this description. “Network address” of a device means any address or identifier within a network which can be used to enable other devices and/or a served to find this device and communicate with it, for example, send messages to it and receive messages from it. It can be a physical (MAC address), a network address (for example, IP address), a symbolic address (a regular computer name or a fully qualified domain name), or any other type of identifier that would serve the stated purpose. The “current voting network” is the network formed by devices of voters admitted to this voting and the server. The “voting message” contains a voter's vote, and might additionally contain a message created by the voter and/or other information envisaged in this description. The term “List” refers to both ordered and unordered sets consisting of both the same type and dissimilar elements. “Open access” refers to any combination of the ability to view content using another computer device, the visualization of content on a display for viewing by the user, and the ability to copy content, with the possibility of limiting the group of people who have this access. “Published” means placed on open access. “Hidden saving” and “hidden storage” mean that the saved content cannot be viewed by the user of the device and cannot be copied. “Rhythmic mailing” means messaging carried out by several devices in steps, so that in each step each device send its message following a common synchronization (sync) signal. “Anonymizing mailing” means any messaging that leads to the distribution of messages created by devices connected to a network among these devices, in such a way that each device receives all these messages, but has no information about which device sent which of them. Particular implementations include MixNet method and the Oblivious Shuffle method described in patent EP3574482B1, or the method described in the fourth independent paragraph of this patent.

### Formation of Groups

Those who intend join the voting are checked for compliance with the criteria or the voter list set by the voting organizers and authenticated, for example, through cross-authentication using video selfies (according to the method described in patent US20240244049A1). The devices of voters who have passed authentication join the network and are admitted to participate in several stages of voting.

As the devices enter each stage of voting, the server forms groups based on the number of participating devices and the timing of entering current stage of voting. For example, each group can have a selected number of devices, which can be determined, in accordance with the total number of potential participants in this vote (for example, in the case of a large number of potential participants, the group may include one hundred participants, and in the case of a small number, say, less than one hundred, the group may consist of twenty participants). The server informs each participant of a group of the network addresses other participants of the same group and the credentials of the current voting and the group they belong to. As groups are formed, the server creates a registry of groups, which can be used to find the network address of each participant in each group.

In one of the implementations, the server generates a pair consisting of private and public keys of asymmetric encryption used to identify the current voting (in a separate case, the server generates a separate pair for each group) and transmits to each device included to the group, along with the network addresses of other group members and the public key from this pair (in the above-mentioned separate case, the server passes a key specific to this group).

### Anonymizing Mailing

In all voting processes, the main role is played by an anonymizing mailing, through which the voting devices anonymously transmit messages created by them to each other and forward them to the server.

Each device of each group generates a pair consisting of public and private keys of asymmetric encryption for anonymizing mailing and sends the generated public key from this pair to all devices in its group. Each device, having received the public keys of the anonymizing mailing, saves them along with the senders' network addresses. Then, each device in the group randomly selects an equal number of these public keys from those stored, makes up a sequence of them—a forwarding chain—and saves it.

Then, each device encrypts its initial message to be sent with the first key from the forwarding chain it had saved. Then, it attaches this key to this message and saves it. Then the device encrypts what came out using the second public key from the chain of keys saved its, attaches that key to the result of encryption, and saves it again. It continues doing this with the third key, fourth key, and so on until it has used all the keys it has saved in the forwarding chain.

At the end of this procedure, all participating devices begin to forward messages. These shipments can be made in two different ways. In the first one, each device sends messages to all the devices in the group and receives messages from each of them. Among the messages it receives, finds those to which its own key of the anonymizing mailing is attached and decrypts them. In the second option, each device sends a message only to the device which generated the key of the anonymizing mailing attached to this message. In this variant, devices receive only those messages that are encrypted with their own key of the anonymizing mailing and therefore decrypt all received messages.

This procedure is repeated until a message obtained as a result of last decryption is completely decrypted. The device saves such a message and sends it to all the devices of the group and the server. Each device also saves all fully decrypted messages received from other devices.

The process of sending and receiving messages in the group transpires in cycles. All messages are provided with a flag indicating the stage (clock cycle) in which they are sent. At the same time, each device records the number of messages sent and received by it during the time allotted for the clock cycle and reports these numbers to all devices of the group and the server. At the end of each clock cycle, the server and each of the devices calculate two control numbers: the total number of all messages sent by all devices of the group, and the total number of messages received by all devices of the group. These numbers should not change during the transition from clock cycle to clock cycle and should match the number of devices in the group. The next clock cycle should be started only if this condition was met in the previous clock cycle.

The result of the anonymizing mailing is a complete list of initial messages stored on all the group's devices and on the server, completely disconnected from their creators. Countering malicious actors during an anonymizing mailing

An unscrupulous server and/or one or more malicious devices may make distortions in the course of anonymizing mailing. These distortions may include stuffing or substitution of votes.

To counteract stuffing during anonymizing mailing, the server and all devices of the group control the total number of all messages sent by all devices of the group and the total number of messages received by all devices of the group at each clock cycle. In case the correct preferred procedure, each device sends only one message in the first clock cycle, and on each subsequent clock cycle it sends as many messages as it received in the previous clock cycle. Failure by the device to comply with this condition immediately allows both the server and all the devices of the group to detect that it is unscrupulous.

If in any clock cycle the total number of messages received by all devices is less than the number of devices in the group, and at the same time the total number of messages sent coincides with the number of devices in the group, it is advisable to repeat the last clock cycle.

If in any clock cycle the total number of messages received by all devices is greater than the number of devices in the group, and at the same time the total number of messages sent coincides with the number of devices in the group, the reason for this may be either failure by some devices to properly send messages or incorrect reflection by some devices of the number of messages received (or both). In this case, the new clock cycle does not start, and each device creates a report containing information about which devices it received messages from and which devices it sent messages to in one or several previous cycles. Each device sends this report to the server and all devices of the group. If both the sender and the receiver devices operate correctly they should both report the same transaction. Devices violating this condition are marked as suspicious. To find a malicious device among the suspected devices, it is enough to repeat the clock cycle of the entire anonymizing mailing procedure several times, each time changing the recipient chains for all devices. A device marked as suspicious several times (a selected number of times) is then considered malicious and is subject to exclusion from the group. This procedure is repeated until a successful anonymizing mailing is carried out.

To counteract the substitution of votes in the voting results, the messages received by the devices of the anonymizing mailing are posted on each group's devices. If, at the end of a successful anonymizing mailing, there is a device that cannot find its message, then a substitution must have has occurred. The device that detected the substitution informs all the devices of the group about it. After that, each device of the group creates a report containing the recipient chain created by it in the beginning of the anonymizing mailing. Each device sends this report to the server and the devices of the group. In this situation, the device that reports the substitution and the devices indicated in its recipient chain are marked suspicious. To identify a malicious device, the anonymizing mailing is repeated several times, each time changing the chains of recipients for all devices. A device marked suspicious several times (a selected number of times) is considered malicious and is subject to exclusion from the group. This procedure is repeated until a successful anonymizing mailing is carried out.

Malicious actions on the part of user devices are potentially possible if their configuration is distorted. Therefore, further participation of the device excluded from the group is only possible after restoring its configuration.

### The First Stage of Voting—Joining the Voting

Only the device of a voter who has successfully passed authentication (establishment of the right to participate in the current voting) can join the network of the current voting. The list of network addresses of devices that have joined the network or unique features of successfully authenticated voters is placed in open access.

To prevent two key issues—first, a voter submitting multiple votes, and second, the appearance of excess votes in the voting results (those not originated from authenticated voters)-two approaches are proposed. In the first approach (described in detail below), a device of an authenticated voter generates a unique identifier that tracks the inclusion of their vote in the final tally. In the second approach (described in detail below), only devices belonging to successfully 7authenticated voters are permitted to participate in any stage of the voting process.

In the first approach, a device that enters the voting for the first time creates an identifier consisting of two parts, a control (hidden) one and an open one, for which there is a procedure to confirm their compliance with each other. The corresponding parts of the identifier can be a pair of private and public keys of asymmetric encryption or a pair of an encryption key (a hidden part) and a concatenation of an arbitrary text with the result of its encryption with this key (a public part), etc. Devices associate these parts with the credentials of the current vote and store them in a hidden form, that is, none of these parts can be viewed on the device that generated them. Each device generates a message consisting of an open part of the identifier and sends it, using the anonymizing mailing procedure, to all devices of its group, which is spontaneously formed as the devices join the current voting network. As a result, each device of the group and the server have a complete list of open parts of the identifiers of devices belonging to this group, each of the devices stores its identifier, and none of them has information which devices synthesized the rest, while each of the devices keeps its identifier secret.

In the second method, the role of the identifier is played by the voting key, and only one voting key from one device can be used at the stage of vote counting.

Thus, in the first approach, a list of open parts of the identifiers of these devices placed in open access on the server and on each of the group's devices, along with a list of network addresses of devices that joined the current voting. The coincidence of the number of lines in these lists should serve as confirmation of the absence of bots. The absence of repetitions in each of them serves as confirmation of the single-time participation of one device. Similarly, in the second approach, the number of network addresses must match the number of voting keys used at the vote counting stage.

### The Second Stage of Voting—Casting the Votes

A device that has successfully completed the first stage of voting receives an electronic ballot from the server, in which several alternatives are presented to the voter. The device saves this ballot during the entire voting. In this ballot, the voter can select one or more alternatives (following the rules for the current voting). After completing the selection of alternatives, the voter can give the command to their device to submit their selection. In response to this command, the voter's device creates a voting message which includes the selection made by the voter and may include the credentials of the current voting, the date and time. The voter has the opportunity to change the selection during the time allotted for vote casting. The voter can give a command to accept a new selection, in response to which the device will create a new voting message which will include the new selection and also may include the same After completing the selection of alternatives, the voter can give the command to their device to submit their selection. In response to this command, the voter's device creates a voting message which includes the selection made by the voter and may include the credentials of the current voting, the date and time. of the current voting and date, but with a different time. In addition to the above, the voter can add any information to the voting message, for example, some information about the voter, which is not personal identifiable information, for the sake of conducting a sociological analysis of the voting results.

In the embodiment of the invention, where each device creates a unique identifier consisting of two parts, the device can include both parts of this identifier in each voting message. In the particular case, when the two parts of the identifier are represented by an asymmetric encryption key pair, the voting message can be electronically signed using the private key from this key pair.

In the embodiment of the invention where a device receives a public key identifying the current voting from the server, the device completes the creation of its voting message by encrypting this message with this key and attaching this key to the encrypted message.

After creating a voting message, various procedures can be implemented. In one of these procedures, only one voting key is generated and used during a single voting by each device, but each new voting message includes an indication of the time at which it was created (a time stamp). In another procedure, a new voting key is generated for each voting message, and no time stamp is necessary in the voting message. In this case, either the previous key is deleted when a new key is generated or the keys are marked so that the latest key can be identified, for example, by numbering the keys. Further in the description, we refer to these procedures as the “first” and “second” voting procedures.

In both procedures, the device encrypts the voting message with the voting key it generated and sends the encrypted message to all devices of its group and to the server using an anonymizing mailing. As a result, a set of encrypted voting messages appears and is saved on each device of the group and the server. Symmetric and asymmetric encryption voting keys can be used to encrypt and decrypt voting messages.

The device saves the voting key it used. The device sends this key only after the time allotted for vote casting has elapsed, during the third stage of voting (i.e., vote counting), using an anonymizing mailing.

To facilitate the search for the particular key decrypting an encrypted voting message during the vote counting, a label can be created by a voter's device and attached to each encrypted message and/or the key encrypting it. Examples of such a label include an alias generated by the device and attached to the key and message, a hash of the key attached to the message, or a hash of the message attached to the key, etc. The label can also be useful to facilitate checking the presence of the sent message in the results of the anonymizing mailing and to verify a voter's vote when the voter voluntarily discloses their vote.

Each time a new voting message needs to be sent, the device can be included in another (currently forming) group. The devices that participated in several anonymizing mailings retain lists of encrypted voting messages that passed through them in each of these groups and network addresses of the devices included in these groups. At the same time, a complete set of encrypted voting messages will be collected on the server, representing the interim results of the voting (in an encrypted form).

The voting key is saved in a hidden way on the voter's device. The fact that the voting key remains hidden from everyone until the end of vote casting ensures that it is impossible to substitute a voting message, that is, to create a message with different content encrypted with the same key.

### The Third Stage of Voting—Counting the Votes

After the time allotted for vote casting has elapsed, the server stops the formation of vote casting groups, starts the formation of vote counting groups, and informs all devices participating in the voting about this. After receiving this information, the device of each of the voting participants creates a message containing the private voting key it saved earlier. It sends this message to all devices of the group being formed at that moment and the server using an anonymizing mailing. In the case of implementation of the second voting procedure, the latest voting key is placed in the message distributed using the anonymizing mailing.

If the public key of identification of the current voting was used in encryption of the voting messages, the server, when starting the vote counting stage, sends the opening (private) key from the key pair identifying the current voting to all devices.

When the time allotted for sending out the voting keys elapses, and the vote counting stage proceeds, the server places in open access the registry of groups formed at the stage of vote casting as well as the full list of the voting keys it has received. This list consists of parts, each of which was sent to the server by devices of one group formed during the anonymizing mailing of these keys. In this case, each device can check the presence and completeness of the part of this list that it received and saved during the anonymizing mailing.

In one of the implementations, the server and each device that has joined the vote counting process find the voting keys that can decrypt the voting messages they have saved in the full list of voting keys in open access. Labels attached to the voting keys and/or the voting messages can be used to facilitate the search for the keys. Using the keys that the devices and the server have found, the devices and the server independently of each other decrypt the voting messages they have saved. The messages that could not be decrypted due to the absence of a suitable encrypting key can be placed in container 1 specially created for this purpose.

In the implementation variant in which identifiers consisting of two parts are created by voter devices and open parts of these identifiers are placed in the voting messages, the devices and the server check whether the open part of the identifier contained in a decrypted message was published in the list of open parts of the identifiers at the beginning of the voting and whether the open and closed parts of this identifier correspond to each other. The devices and the server put messages for which this is not the case in container 2 specially created for this purpose. In the case of the first voting procedure, the devices and the server identify messages with the same identifiers and keep only one of them in the list—the last one in time (the rest are removed from the list). In the case of the second voting procedure, in which only the last voting key is sent out by each device, there cannot be messages with the same identifier in the list of encrypted voting messages, thereby no reconciliation of the list of encrypted messages is needed.

In the implementation variant in which the identifiers used by the voters' devices are the voting keys and the first voting procedure is used, the devices and the server identify messages with the same label and keep only one of them in the list of encrypted voting messages—the last in time (the rest are removed from the list).

After these actions are completed, the server retains a full list of decrypted voting messages, which it places in open access. At the same time, parts of this list are saved in open access on voter devices that obtained them independently of the server and each other. Each device that participated in the voting can verify the presence of its part of the list of voting messages in the full list stored by the server. The decrypted voting messages are saved with an indication of the voting keys with which they were decrypted or their labels. The preliminary (encrypted) messages are saved with an indication of the voting keys with which they were encrypted or their labels. The server can publish the decrypted voting results, for example, on a website, as a list of lines, each of which contains the vote of one voter, the identifier of this voter, and the additional file attached by the voter.

The counting of the number of votes cast for each of the alternatives present on the ballot is carried out by each device independently of other devices and ends with the exchange of results in its voting groups and in the entire voting network, including the server that places them in public access, providing an opportunity to check them for a select group of people which may include everyone, and not only those who voted.

A select group of people can verify at the end of the vote counting that both containers (1 and 2) should are empty, and that the number of unique voting participants (the number of identifiers and/or network address) matches the number of voting messages in the final results (in the case of the second voting procedure, also the preliminary results).

### Distributed Saving of the Voting Results

At the completion of the vote counting, each device participating in it saves: 1) a list of anonymizing mailing public keys linked to the network address of the devices that generated these keys with which this device participated in anonymizing mailings; 2) a list of decrypted voting messages which were created by the devices which participated with this device in the same vote casting groups for anonymizing mailings of voting messages; 3) a list of not yet decrypted voting messages from the devices which participated with this device in the same vote casting groups for anonymizing mailing of voting messages; 4) a list of voting keys that were used to encrypt the voting messages from the saved list of messages. At the same time, the server stores: 1) a complete list of anonymizing mailing public keys linked to the network address of the devices that generated these keys; 2) a complete list of voting messages encrypted with appropriate voting keys; 3) a list of fully decrypted voting messages; and 4) a complete list of voting keys. In addition, a registry is formed on the server containing information about the composition of groups, in each of which all devices store the same part of each of the lists, as well as about the composition of messages included in these parts. All of the above information is placed in open access.

It is envisaged, first, that the device checks the immutability of lists stored on the server by checking the presence in these lists of parts (fragments) of these lists stored by this device, and second, that the device checks the completeness of lists stored on the server by sequentially or randomly viewing fragments of these lists requested from a selected device storing this fragment which is online at the time of the request.

### Protection Against Coercion and Vote Trading and Verification of Voting Results

The overall practice of voting in various countries has shown that the threats to the voting process include: buying and selling of votes, pressure on voters from, e.g., supervisors at work, and forcing voters to cast their votes in the presence of an observer/overseer.

The above procedures for casting and counting of votes ensure that it is impossible for a voter to demonstrate their vote in the voting results (for sale or under pressure).

To verify the voting results, zin the present invention, a method is claimed that provides an opportunity for each voter to check whether their vote was accounted for in the final voting results. This method assumes that this opportunity can be used only after the voter has expressed their willingness to disclose their vote (waive the secret of their vote). At the same time, the method ensures that a voter cannot commit forgery and/or stipulate the system.

In this method, in the first clock cycle of a rhythmized anonymizing mailing of voting messages, each device additionally sends its sequentially encrypted voting message to several devices selected in such a way that their public keys of the anonymizing mailing are not attached to this message. Each device that received one or several of these voting messages (that have attached public keys generated by other devices) verifies that each of these messages is identical to the voting message received by the device that generated the public key of the anonymizing mailing attached to this message. There are multiple ways in which this can be done. In one implementation, the device that generated the public key of the anonymizing mailing attached to this message forwards this voting message to the device that requested it. In another implementation, a device sends its sequentially encrypted voting message to all devices participating in the current anonymizing mailing. If the verification is successful, then the device that received the voting message, to which the key of another device is attached, saves this message with an attached network address of the device that sent this message.

When the vote disclosure is launched by the initiative of a voter, a peer-to-peer verification network is created, which is joined by the devices that took part in that voting. A device that has saved a voting message from this voter, to which a public key of another device and the network address of the device of the voter that initiated the disclosure their vote are attached, forwards this message to the device that generated the public key of the anonymizing mailing list attached to this message.

A device that has received voting messages in the vote disclosure procedure, to which the public key of the anonymizing mailing generated by it is attached, decrypts this message. If a public key of the anonymizing mailing attached to the decrypted message, then this device forwards this message to the device that generated this public key. A device that has obtained a voting message (as a result of its decryption) with no key attached to it, sends this message to all devices connected to the peer-to-peer verification network. After that, all devices connected to the verification network can compare this voting message with the message in the final list of encrypted voting messages (encrypted by voting keys).

The coincidence of the messages means that the vote of the voter who reveals their vote is correctly accounted for in the voting results.

1. A system which includes a server and user devices connected into an overlay network wherein the server is configured to
starting and stopping a voting,
generating synchronizing signals (sync signals) for anonymizing mailings,
receiving and accumulating messages during anonymizing mailings, including voting messages and messages containing voting keys generated by user devices,
decrypting votes in the accumulated voting messages with the voting keys,
counting the number of votes cast for each of the alternatives in the accumulated voting messages,
saving these numbers and placing them in open access,
the user's device is configured to
interacting with other devices of the voting network in a peer-to-peer manner,
receiving a voter's vote,
creating voting messages containing the voter's vote, and encrypting these messages with voting keys generated by the device,
creating messages containing voting keys,
mailing the messages created by the device using anonymizing mailings which use the synchronizing signals (sync signals) generated by the server ensures that the device can send only one message during one anonymizing mailing.

2. The voting system of claim 1, wherein the user's device and/or the server are further configured to
saving the messages received during the anonymizing mailings,
counting the number of votes cast for each of the alternatives in accumulated voting messages, and
saving these numbers and placing them in open access.

3. The voting system of claim 1, in which the device is further configured to join a voting network through cross-authentication of the voter.

4. The voting system of claim 1, wherein
the server is additionally configured to
form a network of current voting and maintain a registry of devices joining this network,
form groups from the devices of authenticated voters connecting to the network of current voting,
distribute network addresses of user devices in each of the groups among these devices,
the device is additionally configured to
join the network of the current voting, and
receive and save the network addresses of all devices in groups in which it is included.

5. The voting system of claim 1, wherein
the server is further configured for
generating for each voting a pair of private and public keys of asymmetric encryption identifying the current voting, and sending the public key from this pair to the devices of all participants of this voting,
the device is further configured for
receiving a public key identifying the current voting from the server and encrypting voting messages with it before sending them using anonymizing mailings, and
receiving from the server, at the end of voting, a private key identifying the current voting, and completing the decryption of the voting message using this key.

6. The voting system of claim 2, wherein
the server is additionally configured for
launching various anonymizing mailings at different stages of the current voting in groups of voter devices formed by it,
maintaining validity of an anonymizing mailing by restarting it and/or changing the composition of the group in which it is conducted, in case of failures detected during this anonymizing mailing,
the device is additionally configured to
generate and save a pair of private and public keys of asymmetric encryption for anonymizing mailings, and distribute the public key from this pair to the devices of the current voting network,
receive public keys for anonymizing mailing from the devices of the current voting network, saving them with network address of their senders, and
countering malicious actors during an anonymizing mailing.

7. The voting system of claim 1, wherein
the server and the device are further configured for
decrypting encrypted voting messages at the stage of vote counting, and saving them in open access after the decryption,
forming a final list of decrypted voting messages by deleting needless messages and leaving only the latest voting messages from each user, saving this list and placing it in open access, and
counting the votes results based on the list of remaining decrypted messages, saving the voting results, and placing them in open access.

8. The voting system of claim 1, wherein
the server is additionally configured for
saving information about the breakdown of the full list of stored voting messages into parts which were formed during the anonymizing mailings, with fixation, firstly, the lists of devices that participated in one of anonymizing mailing, secondly, the lists of messages that occur in these parts of the full list,
creating a consolidated registry storing information about the breakdown of devices into groups, in each of which all devices store the same part of the full list of voting messages, and placing this registry in open access
the device is additionally configured for
saving voting messages received by it from other devices through an anonymizing mailing, providing open access to these messages to devices of all authenticated voters that have joined the current voting network,
forming their final list of decrypted voting messages and reconciling it with a corresponding part of the full final list of decrypted voting messages stored by the server, and
independently counting the votes cast for each of the alternatives, based on the full final list of decrypted voting messages distributed among the devices participating in the voting, by sequentially viewing fragments of this list requested from a randomly selected device storing this fragment and connected to the voting network at the time of the request.

9. The voting system of claim 1, wherein the device is additionally configured for
checking the immutability of the full list of voting messages stored on the server by checking the presence of own its part in this list at selected time,
checking the completeness of the full list of voting messages stored on the server, by sequentially viewing all fragments of this list, requested from a selected (for example, randomly) device storing the requested fragment, and connected to the voting network at the time of the request, and
sending the results of these checks to the server.

10. The voting system of claim 1, wherein the device is additionally configured for including, at the initiative of the voter, arbitrary information in voting messages, for example, non-personalized personal information about this voter.

11. A method of conducting secret remote voting, which includes
joining a network of a current voting by a device of a voter who has successfully authenticated,
creating and placing in open access a list of network addresses of devices that have joined the network of the current voting,
creating by a device of a successfully authenticated voter that joined the current voting network for the first time an identifier consisting of two parts, for which there is a procedure to confirm their coherence with each other,
ensuring the absence of the possibility of creating a second identifier by the voter's device,
hidden saving by the voter's device of both parts of the identifier,
distributing the open part of the identifier using an anonymizing mailing to devices of voters who joined the current voting network,
including this open part in the published list of open parts of the identifiers of all devices that joined the current voting network,
creating a voting message by a voter's device that has joined the current voting network, including the user's vote and the identifier in this message, and encrypting the created voting message with a voting key generated by this device, which is hiddenly stored by this device,
distributing by a voter's device voting messages created and encrypted by this device over the current voting network using anonymizing mailings during the time allotted for vote casting,
saving by a voter's device encrypted voting messages received from other devices during the anonymizing mailings,
creating a list of all encrypted voting messages distributed by voters' devices, saving this list, and placing it in open access,
distributing by a voter's its voting key over the network of the current voting using an anonymizing mailing after the vote counting has started,
creating a list of voting keys sent out by all devices that participated in the voting using an anonymizing mailing, saving this list and placing it in open access,
decrypting stored encrypted voting messages using corresponding voting keys,
forming a complete final list of decrypted voting messages using a procedure that allows to leave only the last voting message from each user in this list while maintaining user anonymity, saving this list and placing it in open access, and
counting the votes cast for each of the alternatives based on the voting messages in the final list of decrypted voting messages, saving this result and placing it in open access.

12. The method of claim 11 further comprising
creating and placing in open access a list of the unique features of voters whose devices have joined the network, and
using the list of unique voter features to ensure that it is not possible to create a second identifier by a device of a voter whose unique features were already included in the list of participants of the current voting when the first identifier was created.

13. The method of claim 11 further comprising forming the final list of decrypted voting messages by
identifying in the list of decrypted voting messages such messages that contain the open part of the identifier that is missing in the list of published open parts of the identifiers, deleting all such messages from this list, and
identifying in the list of decrypted voting messages such messages in which parts of the identifier do not correspond to each other, and deleting all such messages from this list.

14. The method of claim 11, in which the procedure for leaving only the last voting message from each user while maintaining the anonymity of the user is the inclusion of the time of the creation of the voting message or its serial number in each voting message by the device, and identifying in the list of fully decrypted messages those messages in which the identifiers match, determining among them the latest one or the one with the last serial number and leaving only such messages in the final list.

15. The method of claim 11, in which the procedure for leaving only the last voting message from each user while maintaining the anonymity of the user is the generation by the device of a new voting key each time a new voting message is created and sending the last key during the counting the votes.

16. The method of claim 11, in which
either a pair of private and public keys of asymmetric encryption or a pair of a hidden encryption key and a public concatenation of a text with the result of its encryption with this key are used as corresponding parts of the identifier created by a device of a successfully authenticated voter.

17. The method of claim 11, in which to facilitate the procedure for detecting messages encrypted by a particular voting key, an index of the messages is created which can utilize labels, such as a generated by the device alias attached to the key and message, a hash of the key attached to the message, or a hash of the message attached to the key, etc.

18. The method of claim 11, for the verification of voting results further comprising
sending by a device its sequentially encrypted voting message in the first clock cycle of the rhythmized anonymizing mailing of voting messages to several devices whose public key of the anonymizing mailing is not attached to this message,
receiving by a device a voting message to which the key of another device is attached, checking by the device that this message is identical to the message received by the device whose public key of the anonymizing mailing is attached to this message, and saving this message, attaching to this message the network address of the device that sent it,
launching the vote disclosure procedure by the initiative of a voter and connecting the devices that participated in this voting into a peer-to-peer verification network,
sending the voting message of the voter who is disclosing their vote by a device that stores this voting message with an attached public key of an anonymizing mailing and has not generated this public key to the device that generated this key,
receiving by the device participating in the vote disclosure procedure a message to which the public key of the anonymizing mailing generated by this device is attached and decrypting this message with the private key stored on this device,
forwarding a decrypted message which has a public key of the anonymizing mailing attached to it by the devices that encrypted this message to the device that generated this public key,
forwarding a decrypted message which has no key attached to it by the devices that encrypted this message to all devices connected to the peer-to-peer verification network,
comparing a received message which has no key attached to it with the message in the final list of encrypted voting messages.

19. A method of conducting secret remote voting, which includes
joining a network of a current voting by a device of a voter who has successfully authenticated,
creating and placing in open access a list of network addresses of devices that have joined the network of the current voting,
creating a voting message by a voter's device that has joined the current voting network, including the user's vote, and encrypting the created voting message with a voting key generated by this device, which is hiddenly stored by this device,
distributing by a voter's device voting messages created and encrypted by this device over the current voting network using anonymizing mailings during the time allotted for vote casting,
saving by a voter's device encrypted voting messages received from other devices during the anonymizing mailings,
creating a list of all encrypted voting messages distributed by voters' devices, saving this list, and placing it in open access,
distributing by a voter's its voting key over the network of the current voting using an anonymizing mailing after the vote counting has started, ensuring the condition under which one device can send only one such key,
creating a list of voting keys sent out by all devices that participated in the voting using an anonymizing mailing, saving this list and placing it in open access,
decrypting stored encrypted voting messages using corresponding voting keys,
forming a complete final list of decrypted voting messages using a procedure that allows to leave only the last voting message from each user in this list while maintaining user anonymity, saving this list and placing it in open access, and
counting the votes cast for each of the alternatives based on the voting messages in the final list of decrypted voting messages, saving this result and placing it in open access.

20. The method of claim 19, in which the condition under which one device represented by its network address can send only one voting key for decryption of its voting message is ensured by providing a device with the opportunity to participate in only one successful anonymizing mailing after the launch of vote counting.

21. The method of claim 19 further comprising
creating and placing in open access a list of the unique features of voters whose devices have joined the network, and
using the list of unique voter features to ensure that only one device of one voter can send only one voting key for decryption while counting the votes.

22. The method of claim 19, in which to facilitate the procedure for detecting messages encrypted by a particular voting key, an index of the messages is created which can utilize labels, such as a generated by the device alias attached to the key and message, a hash of the key attached to the message, or a hash of the message attached to the key, etc.

23. The method of claim 19, in which the procedure for leaving only the last voting message from each user while maintaining the anonymity of the user is the inclusion of the time of the creation of the voting message or its serial number in each voting message by the device, and identifying in the list of fully decrypted messages those messages in which the identifiers match, determining among them the latest one or the one with the last serial number and leaving only such messages in the final list.

24. The method of claim 19, in which the procedure for leaving only the last voting message from each user while maintaining the anonymity of the user is the generation by the device of a new voting key each time a new voting message is created and sending the last key during the counting the votes.

25. The method of claim 19, for verification of voting results, further included
sending by a device its sequentially encrypted voting message in the first clock cycle of the rhythmized anonymizing mailing of voting messages to several devices whose public key of the anonymizing mailing is not attached to this message,
receiving by a device a voting message to which the key of another device is attached, checking by the device that this message is identical to the message received by the device whose public key of the anonymizing mailing is attached to this message, and saving this message, attaching to this message the network address of the device that sent it,
launching the vote disclosure procedure by the initiative of a voter and connecting the devices that participated in this voting into a peer-to-peer verification network,
sending the voting message of the voter who is disclosing their vote by a device that stores this voting message with an attached public key of an anonymizing mailing and has not generated this public key to the device that generated this key,
receiving by the device participating in the vote disclosure procedure a message to which the public key of the anonymizing mailing generated by this device is attached and decrypting this message with the private key stored on this device,
forwarding a decrypted message which has a public key of the anonymizing mailing attached to it by the devices that encrypted this message to the device that generated this public key,
forwarding a decrypted message which has no key attached to it by the devices that encrypted this message to all devices connected to the peer-to-peer verification network,
comparing a received message which has no key attached to it with the message in the final list of encrypted voting messages.

26. A method of anonymizing mailing of messages by devices using their grouping and rhythmization of their actions by the server, wherein
the server
forms groups of devices joining the anonymization process,
generates synchronization (sync) signals, according to which the devices simultaneously perform the same actions, that is, in clock cycles
the device
receives and stores a list of network addresses of all members of the group in which it is included,
generates a pair of the public and private keys for the anonymizing mailing and distributes the public key from this pair to all devices of the group,
receives the public keys of the anonymizing mailing from all devices of the group and saves them with attachment of each key to the network address of its sender,
generates and saves a forwarding chain (sequence) consisting of network addresses and associated keys of the anonymizing mailing of the devices from the group,
performs sequential encryption of a message to be mailed with the keys of the anonymizing mailing from the forwarding chain, and attaches to the encrypted message the key with which it is encrypted at each step of encryption,
sends encrypted messages (including the message obtained as a result of the sequential encryption and messages received from other devices and encrypted by this device) to those devices that generated the public keys of anonymizing mailing attached to these messages,
receives encrypted messages with attached keys of anonymizing mailing from the devices of the group and decrypts these messages with its private key,
sends fully decrypted messages to all devices of the group and the server, and
performs sending and receiving messages in clock cycles, so that in the first clock cycle it sends one message created by it, and in each subsequent clock cycle it sends as many messages as it received in the previous clock cycle.

27. The method of claim 26 further comprising
sending in each clock cycle by each device of the group to all devices of the group and to the server a message containing the number of messages received and sent by this device in this clock cycle, receiving similar messages from all devices of the group,
launching the next clock cycle by the server if the total number of all messages sent and received by the devices of the group in the current clock cycle coincides with the total number of devices in the group, and
repeating the current clock cycle if the number of all messages received and/or sent by the devices of the group in the current clock cycle does not match the total number of devices in the group.

28. The method of claim 26 further comprising, when the total number of all messages received and/or sent by the devices of the group in the current clock cycle does not match the total number of devices in the group during a select number of repetitions of the current clock cycle,
sending by each device of the group the list with network addresses of devices to which it sent the messages and the list with network addresses of devices from which it received the messages in the current clock cycle,
identifying, from a comparison of these lists, those devices that reported receiving at least one message from a device that did not report sending message to them, those devices that did not report receiving messages from at least one device that reported sending at least one message to them, those devices that report sending at least one message that was not reported as received by the recipient device, and those devices that reported receiving a message from at least one device that did not report sending a message to them, creating a defective device list of the current anonymizing mailing, consisting of such devices identified by all devices in the group,
terminating the current anonymous mailing and launching a new anonymizing mailing in the same group of devices, using new forwarding chains (newly generated for this purpose),
excluding from a group a device whose network address was found in the defective device lists of a selected number of anonymizing mailings in one group, and conducting a new anonymizing mailing in this group after this exclusion.

29. The method of claim 26 further comprising, if at least one device does not find its message among the messages distributed by devices in the last clock cycle of the anonymizing mailing,
disclosing by each device which did not find their message in the last clock cycle of the anonymizing mailing its forwarding chain with the network address of this device included,
repeating the anonymizing mailing, with the usage of new forwarding chains which include different network addresses, and
excluding from the group each device whose network address was disclosed in a selected number of forwarding chains or anonymizing mailings, and conducting a new anonymizing mailing in this group, after this exclusion.
